(19) United States
(12) Patent Application Publication
(10) Pub. No.: US 2008/0075912 A1
(43) Pub. Date: Mar. 27, 2008

(54) Shielding component, in particular a heat shield

(76) Inventor: Bruno Malinek, Langenzenn (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/889,349

(22) Filed: Aug. 10, 2007

(30) Foreign Application Priority Data
Aug. 24, 2006 (DE) 10 2006 039 756.8

(51) Int. Cl. B32B 1/04; B32B 3/00

(52) U.S. Cl. 428/71; 428/68; 428/75

(57) ABSTRACT

The invention relates to a shielding component, in particular a heat shield, in which at least partially at least one insulating layer (14) is used. Because the insulating layer (14) is formed from a cellular structure, it is built up with the formation of a combination of interacting individual cells, the individual “cell walls” stiffening the overall structure, that is to say, the shielding component as a whole, and the spaces between the “cell walls” made as cavities being used to reduce the weight of the shielding component so that it can be made as a lightweight component.

The invention relates to a shielding component, in particular a heat shield, in which an insulating layer is at least partially used.

Shielding components of this type are known in the most varied embodiments and are widely used especially in automotive engineering. Components designed as heat shields are intended to keep away the heat from engines and their components, such as turbochargers, catalytic converters, etc., which has been released by radiation and/or convection. Since the parts to be shielded which are under consideration constitute not only heat sources, but are also noise sources, in addition to heat insulation, favorable acoustic shielding behavior is also extremely important.

To meet these requirements, it has already been proposed in DE 41 37 706 A1, that an acoustically transmitting metallic carrier as a cover layer be provided as the sound-absorbing heat insulation for a shielding component, with an insulating material located on the carrier in the form of an insulating layer. The insulating material in the known solution is a solid, formed from quartz sand, with a grain diameter of approximately 0.8 to 2 mm. The quartz sand material can be easily placed in existing impressions of the carrier and can be enclosed by the metallic carrier; due to the use of the solid, the known solution, however, has a high weight, and to the extent the shielding part is designed as a multilayer design, there is increased production effort in addition to production costs.

Comparable solutions are also shown in DE 102 53 508 B3 which, as the insulating layer between sheet metal plates, which are designed as cover layers, uses highly dispersed silicic acid which is incompressible like quartz sand, and ensures high heat insulation, and in DE 42 11 409 A1 which as the heat insulating and noise-damping layer as the liner for internal combustion engines of motor vehicle uses glass fiber inserts which among other things are provided with mineral fillers, such as quartz sand or basalt wool.

On the basis of this prior art, the object of the invention is to improve the known solutions while retaining their advantages, specifically to ensure good acoustic and heat absorption, such that at low production costs a lightweight design for the shielding component can be accomplished. This object is achieved by a shielding component with the features of claim 1 in its entirety.

In that, according to the characterizing part of claim 1, the insulating layer is formed from a cellular structure, it is designed with the formation of a combination of interacting individual cells, the individual “cell walls” stiffening the overall structure, that is to say, the shielding component as a whole, and the spaces between the “cell walls” made as cavities being used to reduce the weight of the shielding component so that it can be made as a lightweight component. The cellular structure moreover has clearly improved acoustic and vibration damping compared to a solid insulating layer, for example built from dense materials, fiber composite materials or solid mineral beds, such as quartz sand. The internal cellular structure of the shielding component reduces the density with a simultaneous increase of the tensile and compressive strength values. The cellular structure of the shielding component also allows increased absorption of deformation energy; this in turn benefits deformation behavior in operation of the shielding component.

The respective cellular structure used as an inherently stable layer as a rule can form the shielding component; in one preferred configuration it is, however, provided that the respective insulating layer extends at least partially along at least one cover layer in order in this way to protect the cellular structure, which may be prone to abrasion, against mechanical damage. It has furthermore proven especially advantageous to form the cellular structure from an open-cell foam, a hollow sphere structure, a honeycomb structure or a screen printed structure. With these cellular structures, insulating layers of geometrically complex shape can be produced so that almost no limits are imposed on the mechanical configuration of the shielding components; this enters into consideration when the shielding material made as a heat shield directly at the site of heat formation must follow complex three-dimensional outside geometries, as are dictated for example by the configuration of an engine block, turbocharger or catalytic converter.

For the purposes of an optimized lightweight design with still high strength values, it has proven favorable to use a metal foam for the insulating layer. For purposes of a sandwich construction, it has in turn proven especially favorable to use for the foam an open-pore structure which ensures a large amount of elasticity with simultaneous stability especially when cyclic bending stresses or the like occur.

Other advantageous configurations of the shielding component according to the invention are the subject matter of the other dependent claims.

The shielding component according to the invention will be detailed below using different embodiments as shown in the drawings. The figures are schematic and are not drawn to scale.

FIG. 1 shows in a perspective top view one embodiment of the shielding component designed as a heat shield, a sheet metal cover layer which covers the insulating layer underneath toward the top being shown facing the viewer;

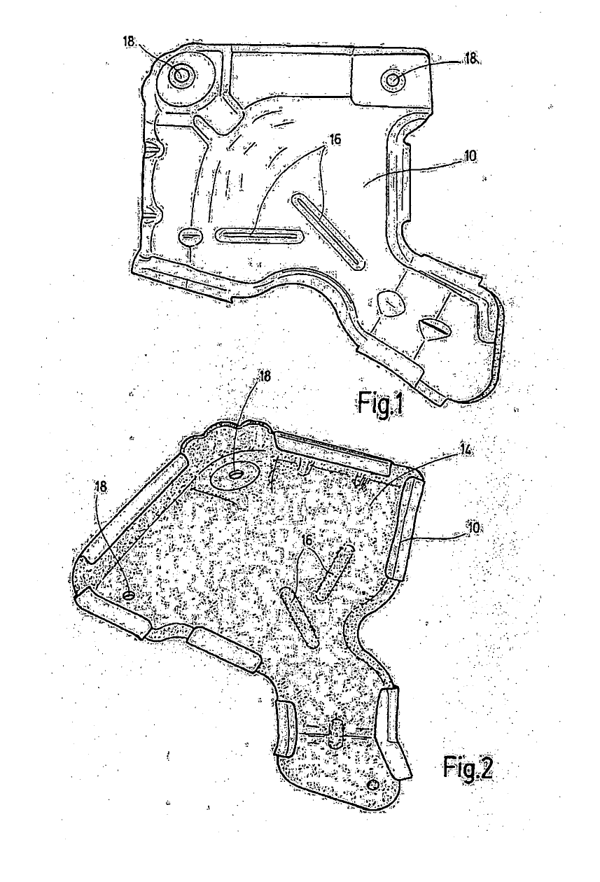

FIG. 2 shows a bottom view of the shielding component as shown in FIG. 1 with the insulating layer which is facing the viewer and which is at least partially overlapped on the edge side by the sheet metal cover layer as shown in FIG. 1;

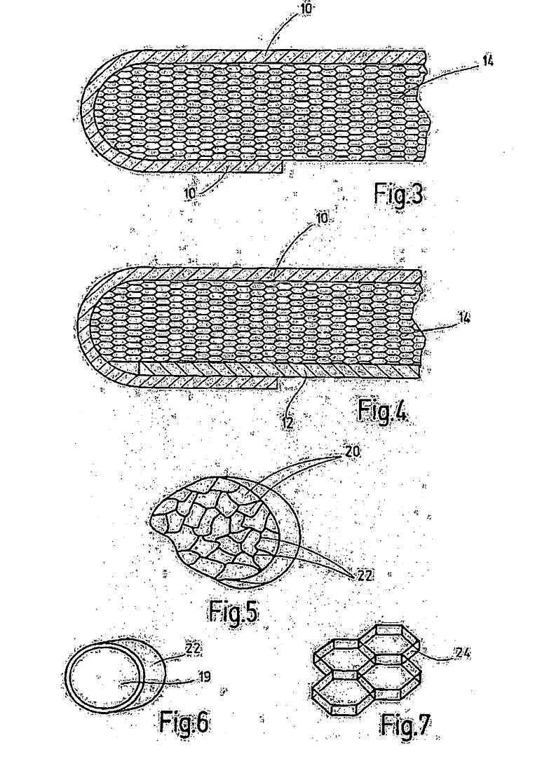

FIG. 3 shows in a schematic a partial cutaway view of the design as shown in FIGS. 1 and 2, in which on the edge side the sheet metal cover layer extends over the inserted insulating layer;

FIG. 4 shows a representation of a modified embodiment corresponding to FIG. 3 with an insulating layer held between two cover layers;

FIGS. 5 and 6 show cutaway one respective individual structure cell each as part of an open-cell space or a hollow spherical structure;

FIG. 7 shows in a perspective top view a cutaway of a honeycomb or screen printing structure.

The embodiment of the shielding component shown in FIGS. 1 and 2 is designed as a heat shield, as is generally required in the automotive domain, an insulating layer 14 of a cellular structure extending along the cover layer 10. As is to be seen in FIG. 2 in particular, the insulating layer 14 is overlapped on the edge side at least partially by the sheet metal cover layer 10 and is held flat on the cover layer 10 in this way. The cover layer 10 can be cut two-dimensionally together with the insulating layer 14 in order to then create a three-dimensional heat shield solution formed jointly in a combination, with impressed stiffening beads 16 and through openings 19 which are used for subsequent fastening of the heat shield in the vehicle interior.

The flanged fastening situation in question is shown in FIG. 3 in a schematic cross section. For the insulating layer 14 as shown in FIG. 2, a so-called hollow sphere structure is used, in which individual cells which can be produced in a defined manner, preferably built up from metallic hollow spheres 19, are connected to one another to form cellular structures. These metallic hollow spheres, as shown in cutaway view by way of example for the individual cell in FIG. 6, can be produced by coating of organic carriers, such as styrofoam balls, and subsequent unbonding in addition to use of a sintering process. In the process, spheres with a diameter between 1.5 and 10 mm at a shell thickness from 20 to 500 μm are formed as the cell wall 22 of the cellular structure. In addition to iron powder, other metal powders are also suited as a coating material and can also form a suspension with a binder.

Essentially this hollow sphere structure could also be obtained by way of a ceramic material, the use of metals for the hollow sphere structure, however, having the advantage that the structure is compressible up to a certain degree. Additionally, the combination of hollow spheres which has been built up in this way is mechanically and thermally stable and resists abrasive influences. Thus it is also possible, by omitting the sheet metal cover layer 10, to make and use the illustrated structure 14 of hollow sphere as an insulating layer directly for a heat shield by means of forming. Precisely by means of the combination of the sheet metal cover layer 10 with the insulating layer 14, the insulating layer 14 is thus protected against abrasive influences, and in particular with a thin execution of the insulating layer 14 the cover layer 10 contributes to stabilization of the entire heat shield and facilitates installation of the heat shield in the interior of the vehicle, such as the engine compartment or the like.

In addition to the indicated structure of hollow spheres or the like, which can be built up from a hollow honeycomb structure or the like, the insulating layer 14 can be a metal foam, in particular in the form of an open-cell foam. In addition to the metal foam, a composite foam using thermally stable plastic materials can also be used for the insulating layer 14, as can ceramic foams which must be sintered for their production, and in contrast to the metal foams which are preferably used, do not exhibit elastically resilient stretching or compressive behavior, this being inherently desirable so that the shielding component or heat shield under thermal stress can reversibly expand under the influence of heat as required.

To obtain a metal foam, for example a process for producing porous metal bodies can be used, as is disclosed by DE 40 18 360 C1. In the known process, first a mixture of a metal powder and a gas-releasing propellant powder is produced. Then this mixture is formed hot compacted into a semifinished product at a temperature at which joining of the metal powder particles takes place primarily by diffusion and at a pressure which is selected to be of such a magnitude as to counteract decomposition of the propellant. The hot compacting is done until the metal particles are tightly joined among one another and in this respect constitute a gas-tight closing-off for the gas particles of the propellant. The semifinished article produced in this way is then heated to a temperature above the decomposition temperature of the propellant and then the body foamed in this way is cooled. The propellants can be metal hydrides, such as titanium hydride or carbonates, but also easily vaporizing substances in the form of pulverized organic substances. Metals here are in particular pure aluminum powder, but also copper powder and the like. Details on production can be found in the indicated patent.

Another process for producing steel foam, in particular in the form of aluminum and nickel foams, is the so-called SlipReactionFoamSinter (SRSS) process, the foaming taking place by a chemical reaction at room temperature. In the process, first the metal powder and the dispersant are mixed, with the formation of a laminar silicate, depending on the alloy content of the metal powder a propellant in the form of a very finely reactive metal powder, for example in the form of carbonyl iron, being added. The concentrated phosphoric acid is added to the solvent, water and/or alcohol, the acid dissociating in the water. A type of slip-like suspension is thus formed in which two reactions proceed in parallel, specifically on the one hand hydrogen gas bubbles forming in the chemical reaction and between the reactive metal particles and the acid and causing direct foaming of the slip, and furthermore a metal phosphate forms which assumes the task of the binder and stabilizes the foam structure. The green compact obtained in this way is then sintered with reduction of the atmosphere to form an open-pore metal foam (see in this context also DE 197 16 514 C1).

Furthermore, the open-cell foam can in turn be obtained by a coating process of polymer foams using metal powder, such as iron powder. This production process then corresponds in turn to a process for producing the respective hollow sphere structure using the subsequent unbending and sintering. In this connection, the materials preferably used are steel or alloys based on nickel, cobalt, and titanium. Likewise intermetallic compounds can be used. The open-cell or open-pore foams produced in this way in addition to high permeability have a large specific surface and accordingly a high degree of heat dissipation capacity. This open pore foam can be made to have large pores or small ones. The open porosity leads to a low rough weight for the foam material and accordingly to a low weight for the entire shielding component. As a result of the pore structure a corresponding metal foam is also elastically resilient and thus can analogously balance thermally induced changes in length or volume. Moreover, in this way a very compressively stiff, loadable, integral article for the respectively desired shielding component results.

An individual cell for a pertinent open-pore foam is shown with its pores 20 and the cell walls 22 which border the pores in FIG. 5 in a section in a type of hemispherical shape. These cells could also be used as a free bulk material in order in this way to be placed in a practical manner in an intermediate space between two cover layers 10, 12 as shown in FIG. 4. In this way, different types of insulating layers 14 could also be joined to one another, for example an open-pore foam, as described above, with closed individual foam cells as shown in FIG. 5. If the insulating layer 14 is formed from a cellular structure of porous foam or as a hollow spherical structure in a plate construction, this structure plate can also be easily placed between the cover layers 10, 12 of the heat shield as shown in FIG. 4, even running bent on the front side, since in this respect the cellular structure is flexible and can follow the respective outline of the cover layers 10, 12 with a reduction of the hollow cavities or pores. Heat dissipation behavior which has been further improved arises if at least one of the two cover layers 10, 12 is provided with openings, for example in the form of a perforation. In this way also at least one cover layer, here the lower cover layer 12, can consist of an expanded metal lattice.

Another possibility for obtaining the desired cellular structure as a hollow structure in the form of a honeycomb structure as shown in FIG. 7 using a metal consists in turn in homogeneously mixing a metal powder, for example in the form of an aluminum powder, with a suitable lubricant powder which is heated as a gastight preliminary material (semifinished article) such that above the metal melting point a metal foam is formed. If then the liquid foam is transferred into the solid phase by rapid cooling below the metal melting point, a solid metal foam forms with a closed, honeycomb outside skin with a closed-pore internal structure located therein. The individual elements or individual cells in a honeycomb structure with a closed surrounding skin 24 as shown in FIG. 7 which have been obtained in this way can also then be placed in several layers as a filling material between the cover layers 10, 12 of the heat shield or can form it autonomously in a sandwich construction with omission of the cover layers.

The honeycomb structure as shown in FIG. 7 can also be obtained via a so-called metallic screen printing process in which in individual steps layered build-up for the honeycomb structure arises. Analogous structuring of the insulating layer 14 can also take place by mask variation. Subsequent unbending and sintering within a large series framework then lead to insulating layers 14 with a specific, extremely diverse pore design.

The cavities (pores) formed by the cellular structure of the insulating layers 14 can moreover be provided with other filler materials, such as fiber materials, solids and the like. In this way, further adaptations to thermal circumstances can be created and/or the indicated structure can be further stiffened.

Using cellular insulating layers for shielding components such as heat shields, in addition to very good thermal insulation and outstanding noise absorption, due to the high energy absorption capacity, good mechanical damping relative to vibrations and impacts is achieved so that a heat shield which has been designed in this way can be considered very durable for later use.

1. Shielding component, in particular a heat shield, in which an insulating layer (14) is at least partially used, characterized in that the insulating layer (14) is formed from a cellular structure.

2. The shielding component according to claim 1, wherein the insulating layer (14) extends at least partially along at least one cover layer (10, 12).

3. The shielding component according to claim 1, wherein the cellular structure is formed from an open-cell foam.

4. The shielding component according to claim 1, wherein the cellular structure is formed from a hollow sphere structure.

5. The shielding component according to claim 1, wherein the cellular structure is formed from a honeycomb structure.

6. The shielding component according to claim 1, wherein the cellular structure is formed from a screen printed structure.

7. The shielding component according to claim 1, wherein the materials used for forming the cellular structure is based on iron, steel, titanium, cobalt, nickel, aluminum, copper, magnesium and high grade steel, including their alloys and with incorporation of intermetallic compounds and all sinterable materials.

8. The shielding component according to claim 1, wherein the cellular structure designed as an inherently stable flat article is encompassed at least partially on the edge side by a cover layer (10).

9. The shielding component according to claim 2, wherein the cellular structure is located between the two cover layers (10, 12), of which one (12) is designed preferably to be permeable, in particular consists of an expanded metal lattice.

10. The shielding component according to claim 1, wherein the pores (18) of the cellular structure are provided with filling media.

11. The shielding component according to claim 1, wherein for a sandwich construction the cover layers (10, 12) alternate with cellular structure layers.

12. The shielding component according to claim 2, wherein the respective cover layer (10, 12) is obtained from a sheet metal material.
